(19) United States
(12) Patent Application Publication
(10) Pub. No.: US 2011/0294955 A1
(43) Pub. Date: Dec. 1, 2011

(54) THERMOPLASTIC POLYESTER ELASTOMER COMPOSITION INCLUDING IONOMER

(75) Inventor: KAZUKI AKIBA, Kennett Square, PA (US)

(73) Assignee: E. I. DU PONT DE NEMOURS AND COMPANY, Wilmington, DE (US)

(21) Appl. No.: 13/113,173

(22) Filed: May 23, 2011

Related U.S. Application Data
(60) Provisional application No. 61/349,224, filed on May 28, 2010.

(51) Int. Cl. C08L 33/02; C08L 33/14; C08L 71/12; C08L 67/02

(52) U.S. Cl. 525/173

(57) ABSTRACT

Disclosed is a composition including a melt mixed blend including (a) 58 to 96.8 weight percent one or more copolyester thermoplastic elastomers; (b) 3 to 40 weight percent polyphenylene ether; (c) 0.1 to 6 weight % ionomer and (d) 0.1 to 8 weight percent of polymeric toughener selected from the group consisting ethylene copolymers of the formula E/X/Y wherein:
E is the radical formed from ethylene;
X is selected from the group consisting of radicals formed from

CH₂═CH(R¹)—C(O)—OR²
wherein R¹ is H, CH₃ or C₂H₅, and R² is an alkyl group having 1-8 carbon atoms; vinyl acetate; and mixtures thereof; wherein X comprises 0 to 50 weight % of E/X/Y copolymer; and
Y is a radical formed from glycidyl (meth)acrylate; and wherein the composition has one or more low temperature glass transition(s) between minus 100 and plus 150° C.
   Also disclosed are molded articles including the compositions, including CVJ boots and air ducts for automotive applications.

### CROSS REFERENCE TO RELATED APPLICATIONS

This application claims the benefit of U.S. Provisional Application No. 61,349,224, filed May 28, 2010.

### FIELD OF INVENTION

The present invention relates to the field of thermoplastic polyester elastomer compositions and molded thermoplastic articles having improved performance at elevated temperatures.

### BACKGROUND OF INVENTION

Thermoplastic polyester elastomers are used in applications that require a combination of high flexural modulus (stiffness) at elevated temperature (e.g. 100° C.), desirable low temperature properties including glass transitions below minus 25° C., and flex fatigue resistance at normal operating temperatures. Elastomeric compositions having a dynamic mechanical analysis (DMA) curve as flat as possible, that is a flexural storage modulus (E′) change as low as possible between minus 40 and 130° C. are desirable. This measure implies that the stiffness of the composition changes little over the temperature range. Most polyester elastomer compositions show a significant drop-off in stiffness above about 50° C.

U.S. Pat. No. 5,295,914 discloses a thermoplastic elastomer seal boot for a constant velocity universal joint, referred to as a CVJ boot. For advanced applications CVJ boots experiencing peak operating temperatures up to about 130° C.-140° C. are required.

EP 150454 A3 discloses a blend of polyetherester copolymers and polycarbonates with improved physical properties.

JP 03505897 discloses a composition comprising a styrene/conjugated diene block copolymer, a thermoplastic elastomer, and a polyphenylene ether and molded articles comprising the composition useful as CVJ boots.

WO2011/043129 discloses a composition comprising a resin component comprising 5-75 wt % polyphenylene ether, 5-40 wt % thermoplastic elastomer and 20-90 wt % polyolefin resin; and a phosphorous and/or nitrogen containing flame retardant.

Needed are thermoplastic elastomer compositions that have good low temperature flexibility, flex fatigue resistance at operating temperatures in the range of 23° C. to 140° C., high stiffness at elevated temperature, and melt flow rates appropriate for rapid manufacturing of molded articles.

### SUMMARY OF INVENTION

Disclosed is a composition comprising a melt mixed blend comprising:
a) 58 to 96.8 weight percent one or more copolyester thermoplastic elastomers;
b) 3 to 40 weight percent polyphenylene ether;
c) 0.1 to 6 weight % ionomer; and
d) 0.1 to 8 weight percent of polymeric toughener selected from the group consisting ethylene copolymers of the formula E/X/Y wherein:
E is the radical formed from ethylene;
X is selected from the group consisting of radicals formed from

CH₂═CH(R¹)—C(O)—OR²
wherein R¹ is H, CH₃ or C₂H₅, and R² is an alkyl group having 1-8 carbon atoms; vinyl acetate; and mixtures thereof; wherein X comprises 0 to 50 weight % of E/X/Y copolymer; and
Y is a radical formed from glycidyl (meth)acrylate;
   wherein the composition has a low temperature glass transition between minus 100 and plus 150° C.

Also disclosed are molded articles comprising the composition as disclosed above including CVJ boots and air ducts for automotive applications.

Also disclosed are uses of the compositions as disclosed above to provide articles having high stiffness at elevated temperature and melt flow rate of about 1.0 or greater.

### DETAILED DESCRIPTION

Disclosed is a composition comprising a melt mixed blend comprising:
a) 58 to 96.8 weight percent one or more copolyester thermoplastic elastomers;
b) 3 to 40 weight percent polyphenylene ether;
c) 0.1 to 6 weight % ionomer; and
d) 0.1 to 8 weight percent of polymeric toughener selected from the group consisting ethylene copolymers of the formula E/X/Y wherein:
E is the radical formed from ethylene;
X is selected from the group consisting of radicals formed from

CH₂═CH(R¹)—C(O)—OR²
wherein R¹ is H, CH₃ or C-M₅, and R² is an alkyl group having 1-8 carbon atoms; vinyl acetate; and mixtures thereof; wherein X comprises 0 to 50 weight % of E/X/Y copolymer; and
Y is a radical formed from glycidyl (meth)acrylate;

wherein the composition has a low temperature glass transition between minus 100 and plus 150° C.

In another embodiment the composition can comprise:

58 to 96.0 weight percent (a);

3 to 30 weight percent (b);

0.5 to 6 weight percent (c); and

0.5 to 6 weight percent (d).

In another embodiment the composition can comprise:

66 to 94.0 weight percent (a);

5 to 25 weight percent (b);

0.5 to 3 weight percent (c); and

0.5 to 6 weight percent (d).

Copolyester thermoplastic elastomers (TPCs) useful in the invention include copolyesterester elastomers, copolycarbonateester elastomers, and copolyetherester elastomers, the latter being preferred.

Copolyesteresters elastomers are block copolymers containing a) hard polyester segments and b) soft and flexible polyester segments. Examples of hard polyester segments are polyalkylene terephthalates, poly(cyclohexanedicarboxylic acidcyclohexanemethanol). Examples of soft polyester segments are aliphatic polyesters, including polybutylene adipate, polytetramethyladipate and polycaprolactone. The copolyesterester elastomers contain blocks of ester units of a high melting polyester and blocks of ester units of a low melting polyester which are linked together through ester groups and/or urethane groups. Copolyesterester elastomers comprising urethane groups may be prepared by reacting the different polyesters in the molten phase, after which the resulting copolyesterester is reacted with a low molecular weight polyisocyanate such as for example diphenylmethylene diisocyanate.

Copolycarbonateester elastomers are block copolymers containing a) hard segments consisting of blocks of an aromatic or semi-aromatic polyester and b) soft segments consisting of blocks of a polycarbonate containing polymeric component. Suitably, the copolycarbonateester elastomer is made of hard polyester segments made up of repeating units derived from an aromatic dicarboxylic acid and an aliphatic diol, and of soft segments made up of repeating units of an aliphatic carbonate, and/or soft segments made up of randomly distributed repeating units of an aliphatic carbonate and either an aliphatic diol and an aliphatic dicarboxylic acid or a lactone, or a combination of these, wherein the hard segments and the soft segments can be connected with a urethane group. These elastomers and their preparation are described in, e.g. EP Pat. No. 0846712.

Copolyetherester elastomers are the preferred thermoplastic polyesters in the resin compositions described herein and have a muitiplicity of recurring long-chain ester units and short-chain ester units joined head-to-tail through ester linkages, said long-chain ester units being represented by formula (A):

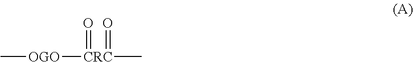

and said short-chain ester units being represented by formula B);

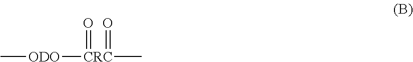

wherein
G is a divalent radical remaining after the removal of terminal hydroxyl groups from poly(alkylene oxide)glycols having a number average molecular weight of between about 400 and about 6000, or preferably between about 400 and about 3000;
R is a divalent radical remaining after removal of carboxyl groups from a dicarboxylic acid having a molecular weight of less than about 300;
D is a divalent radical remaining after removal of hydroxyl groups from a diol having a molecular weight less than about 250.

As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000, and preferably from about 600 to about 3000. Preferred poly(alkylene oxide) glycols include poly(tetramethylene oxide) glycol, poly(trimethylene oxide) glycol, poly(propylene oxide) glycol, poly(ethylene oxide) glycol, copolymer glycols of these alkylene oxides, and block copolymers such as ethylene oxide-capped poly(propylene oxide) glycol. Mixtures of two or more of these glycols can be used.

As used herein, the term “short-chain ester units” as applied to units in a polymer chain of the copolyetheresters refers to low molecular weight compounds or polymer chain units having molecular weights less than about 550.

They are made by reacting a low molecular weight diol or a mixture of diols (molecular weight below about 250) with a dicarboxylic acid to form ester units represented by Formula (B) above. Included among the low molecular weight diols which react to form short-chain ester units suitable for use for preparing copolyetheresters are acyclic, alicyclic and aromatic dihydroxy compounds. Preferred compounds are diols with about 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, etc. Especially preferred diols are aliphatic diols containing 2-8 carbon atoms, and a more preferred diol is 1,4-butanediol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful.

As used herein, the term “diols” includes equivalent ester-forming derivatives such as those mentioned. However, any molecular weight requirements refer to the corresponding diols, not their derivatives.

Dicarboxylic acids that can react with the foregoing long-chain glycols and low molecular weight diols to produce the copolyetheresters are aliphatic, cycloaliphatic or aromatic dicarboxylic acids of a low molecular weight, i.e., having a molecular weight of less than about 300. The term “dicarboxylic acids” as used herein includes functional equivalents of dicarboxylic acids that have two carboxyl functional groups that perform substantially like dicarboxylic acids in reaction with glycols and diols in forming copolyetherester polymers. These equivalents include esters and ester-forming derivatives such as acid halides and anhydrides. The molecular weight requirement pertains to the acid and not to its equivalent ester or ester-forming derivative.

Thus, an ester of a dicarboxylic acid having a molecular weight greater than 300 or a functional equivalent of a dicarboxylic acid having a molecular weight greater than 300 are included provided the corresponding acid has a molecular weight below about 300. The dicarboxylic acids can contain any substituent groups or combinations that do not substantially interfere with the copolyetherester polymer formation and use of the polymer in the flame retardant compositions of the invention.

As used herein, the term “aliphatic dicarboxylic acids” refers to carboxylic acids having two carboxyl groups each attached to a saturated carbon atom. If the carbon atom to which the carboxyl group is attached is saturated and is in a ring, the acid is cycloaliphatic. Aliphatic or cycloaliphatic acids having conjugated unsaturation often cannot be used because of homopolymerization. However, some unsaturated acids, such as maleic acid, can be used.

As used herein, the term “aromatic dicarboxylic acids” refer to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—. Representative useful aliphatic and cycloaliphatic acids that can be used include sebacic acid; 1,3-cyclohexane dicarboxylic acid; 1,4-cyclohexane dicarboxylic acid; adipic acid; glutaric acid; 4-cyclohexane-1,2-dicarboxylic acid; 2-ethylsuberic acid; cyclopentanedicarboxylic acid decahydro-1,5-naphthylene dicarboxylic acid; 4,4′-bicyclohexyl dicarboxylic acid; decahydro-2,6-naphthylene dicarboxylic acid; 4,4′-methylenebis(cyclohexyl) carboxylic acid; and 3,4-furan dicarboxylic acid. Preferred acids are cyclohexane-dicarboxylic acids and adipic acid.

Representative aromatic dicarboxylic acids include phthalic, terephthalic and isophthalic acids; bibenzoic acid; substituted dicarboxy compounds with two benzene nuclei such as bis(p-carboxyphenyl)methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C₁-C₁₂ alkyl and ring substitution derivatives thereof, such as halo, alkoxy, and aryl derivatives. Hydroxyl acids such as p-(beta-hydroxyethoxy)benzoic acid can also be used provided an aromatic dicarboxylic acid is also used.

Aromatic dicarboxylic acids are a preferred class for preparing the copolyetherester elastomer useful for this invention. Among the aromatic acids, those with 8-16 carbon atoms are preferred, particularly terephthalic acid alone or with a mixture of phthalic and/or isophthalic acids.

The copolyetherester elastomer preferably comprises from at or about 15 to at or about 99 weight percent short-chain ester units corresponding to Formula (B) above, the remainder being long-chain ester units corresponding to Formula (A) above. More preferably, the copolyetherester elastomer comprise from at or about 20 to at or about 95 weight percent, and even more preferably from at or about 50 to at or about 90 weight percent short-chain ester units, where the remainder is long-chain ester units. More preferably, at least about 70% of the groups represented by R in Formulae (A) and (B) above are 1,4-phenylene radicals and at least about 70% of the groups represented by D in Formula (B) above are 1,4-butylene radicals and the sum of the percentages of R groups which are not 1,4-phenylene radicals and D groups that are not 1,4-butylene radicals does not exceed 30%. If a second dicarboxylic acid is used to make the copolyetherester, isophthalic acid is preferred and if a second low molecular weight diol is used, ethylene glycol, 1,3-propanediol, cyclohexanedimethanol, or hexamethylene glycol are preferred.

A blend or mixture of two or more copolyetherester elastomers can be used. The copolyetherester elastomers used in the mixture need not on an individual basis come within the values disclosed herein for the elastomers. However, the blend of two or more copolyetherester elastomers must conform to the values described herein for the copolyetheresters on a weighted average basis. For example, in a mixture that contains equal amounts of two copolyetherester elastomers, one copolyetherester elastomer can contain 60 weight percent short-chain ester units and the other resin can contain 30 weight percent short-chain ester units for a weighted average of 45 weight percent short-chain ester units.

Preferred copolyetherester elastomers include, but are not limited to, copolyetherester elastomers prepared from monomers comprising (1) poly(tetramethylene oxide) glycol; (2) a dicarboxylic acid selected from isophthalic acid, terephthalic acid and mixtures of these; and (3) a diol selected from 1,4-butanediol, 1,3-propanediol and mixtures of these, or from monomers comprising (1) poly(trimethylene oxide) glycol; (2) a dicarboxylic acid selected from isophthalic acid, terephthalic acid and mixtures of these; and (3) a diol selected from 1,4-butanediol, 1,3-propanediol and mixtures of these, or from monomers comprising (1) ethylene oxide-capped polypropylene oxide) glycol; (2) dicarboxylic acid selected from isophthalic acid, terephthalic acid and mixtures of these; and (3) a diol selected from 1,4-butanediol, 1,3-propanediol and mixtures of these.

Preferably, the copolyetherester elastomers described herein are made from esters or mixtures of esters of terephthalic acid and/or isophthalic acid, 1,4-butanediol and poly(tetramethylene ether)glycol or poly(trimethylene ether) glycol or ethylene oxide-capped polypropylene oxide glycol, or are prepared from esters of terephthalic acid, e.g. dimethylterephthalate, 1,4-butanediol and poly(ethylene oxide)glycol. More preferably, the copolyetheresters are prepared from esters of terephthalic acid, e.g. dimethylterephthalate, 1,4-butanediol and poly(tetramethylene ether)glycol.

Examples of suitable copolyetherester elastomers are commercially available under the trademark Hytrel® from E. I. du Pont de Nemours and Company, Wilmington, Del.

The copolyester thermoplastic elastomer can have a Durometer hardness of 55D or less and preferably 50D or less, and most preferably between 40D and 50D, as measured by ISO method 868.

The composition comprises 3 to 40 weight percent polyphenylene ether (PPE). Other embodiments include 3 to 30 weight percent, 5 to 25 weight percent, 6 to 25 weight percent and 6 to 20 weight percent PPE, PPE resins known in the art may be used as the PPE resin (b), for example, homopolymers or copolymers obtained by oxidative polymerization of at least one compound described by general formula (I) wherein each R₁, R₂, R₃, R₄, and R₅ is independently selected from among hydrogen atoms, halogen atoms, hydrocarbon groups, or substituted hydrocarbon groups (for example, halogenohydrocarbon groups).

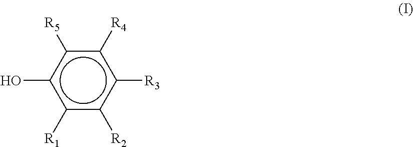

Specific examples of the polymers include poly(2,6-dimethyl-1,4-phenylene) ether, poly(2,6-diethyl-1,4-phenylene) ether, poly(2-methyl-6-ethyl-1,4-phenylene) ether, poly(2-methyl-6-propyl-1,4-phenylene) ether, poly(2,6-dipropyl-1,4-phenylene) ether, poly(2-ethyl-6-propyl-1,4-phenylene) ether, poly(2,6-dimethoxy-1,4-phenylene) ether, poly(2,6-dichloromethyl-1,4-phenylene) ether, poly(.sup.2,.sup.6-dibromomethyl-1,4-phenylene) ether, poly(2,6-diphenyl-1,4-phenylene) ether, poly(2,6-ditrityl-1,4-phenylene) ether, poly(2,6-dichloro-1,4-phenylene) ether, poly(2,6-dibenzyl-1,4-phenylene) ether, and poly(2,5-dimethyl-1,4-phenylene ether. An especially preferred PPE resin is poly(2,6-dimethyl-1,4-phenylene) ether. An example of the polyphenylene ether copolymer is a copolymer containing some amount of an alkyl-3-substituted phenol, for example, 2,3,6-trimethylphenol, in the above-described polyphenylene ether repeating unit Copolymers in which styrene is grafted to these polyphenylene ethers may also be used. Examples of polyphenylene ethers with grafted styrene compounds include copolymers obtained by graft-polymerizing styrene, alpha-methylstyrene, vinyltoluene, chlorostyrene, or the like to the above-described polyphenylene ethers.

Preferably the PPE resins used in the invention have an intrinsic viscosity of 0.15 to 0.65 dLig when measured at 30° C. in chloroform solvent, 0.30 to 0.60 dlig being especially preferred.

The composition comprises 0.1 to 6.0 weight percent, preferably 0.5 to 6 weight percent or 0.5 to 3.0 weight percent, of ionomer. The term “ionomer” as used herein refers to a polymer that comprises ionic groups that are alkali metal ion carboxylates, for example, sodium carboxylates. Such polymers are generally produced by partially or fully neutralizing the carboxylic acid groups of precursor acid copolymers, as defined herein, for example by reaction with abuse. An example of an alkali metal ionomer is a sodium ionomer (or sodium neutralized ionomer), for example a copolymer of ethylene and methacrylic acid wherein all or a portion of the carboxylic acid groups of the copolymerized methacrylic acid units are in the form of sodium carboxylates.

The ionomer polymer comprises an ionomer that is an ionic, neutralized, or partially neutralized, derivative of a precursor acid copolymer. The precursor acid copolymer comprises copolymerized units of an α-olefin having 2 to 10 carbons and about 5 to about 30 wt %, about 5 to 25 wt %, or about 10 to about 25 wt %, of copolymerized units of an α,β-ethylenically unsaturated carboxylic acid having 3 to 8 carbons, based on the total weight of the precursor acid copolymer.

Suitable α-olefin comonomers include, but are not limited to, ethylene, propylene, 1-butene, 1-pentene, 1-hexene, 1-heptene, 3 methyl-1-butene, 4-methyl-1-pentene, and the like and mixtures of two or more of these α-olefins. Preferably, the α-olefin is ethylene.

Suitable α,β-ethylenically unsaturated carboxylic acid comonomers include, but are not limited to, acrylic acids, methacrylic acids, itaconic acids, maleic acids, maleic anhydrides, fumaric acids, monomethyl maleic acids, and mixtures of two or more of these acid comonomers. Preferably, the α,β-ethylenically unsaturated carboxylic acid is selected from acrylic acids, methacrylic acids, and mixtures of two or more acrylic acids or methacrylic acids.

The precursor acid copolymers may further comprise copolymerized units of other comonomer(s), such as unsaturated carboxylic acids having 2 to 10, or preferably 3 to 8 carbons, or derivatives thereof. Suitable acid derivatives include acid anhydrides, amides, and esters. Esters are preferred. Specific examples of preferred esters of unsaturated carboxylic acids include, but are not limited to, methyl acrylates, methyl methacrylates, ethyl acrylates, ethyl methacrylates, propyl acrylates, propyl methacrylates, isopropyl acrylates, isopropyl methacrylates, butyl acrylates, butyl methacryiates, isobutyl acrylates, isobutyl methacrylates, tart-butyl acrylates, tart-butyl methacrylates, octyl acrylates, octyl methacrylates, undecyl acrylates, undecyl methacrylates, octadecyl acrylates, octadecyl methacrylates, dodecyl acrylates, dodecyl methacrylates, 2-ethylhexyl acrylates, 2-ethylhexyl methacrylates, isobornyl acrylates, isobornyl methacrylates, lauryl acrylates, lauryl methacrylates, 2-hydroxyethyl acrylates, 2-hydroxyethyl methacrylates, glycidyl acrylates, glycidyl methacrylates, poly(ethylene glycol)acrylates, poly(ethylene glycol)methacrylates, poly(ethylene glycol) methyl ether acrylates, poly(ethylene glycol) methyl ether methacrylates, poly(ethylene glycol) behenyl ether acrylates, poly(ethylene glycol) behenyl ether methacrylates, poly(ethylene glycol) 4-nonylphenyl ether acrylates, poly(ethylene glycol) 4-nonylphenyl ether methacrylates, poly(ethylene glycol) phenyl ether acrylates, poly(ethylene glycol) phenyl ether methacrylates, dimethyl maleates, diethyl maleates, dibutyl maleates, dimethyl fumarates, diethyl fumarates, dibutyl fumarates, dimethyl fumarates, vinyl acetates, vinyl propionates, and mixtures of two or more thereof. Examples of preferable suitable comonomers include, but are not limited to, methyl acrylates, methyl methacrylates, butyl acrylates, butyl methacrylates, glycidyl methacrylates, vinyl acetates, and mixtures of two or more thereof. Preferably, however, the precursor acid copolymer does not incorporate other comonomers in any significant amount.

Mixtures of precursor acid copolymers are also suitable, provided that the properties of the copolymers are within the ranges described herein. For example, two or more dipolymers having differing amounts of copolymerized carboxylic acid comonomer or differing melt indices may be used. Also, a mixture of precursor acid copolymers including a dipolymer and a terpolymer may be suitable.

The precursor acid copolymer may have a melt flow rate (MFR) of about 10 to about 1000 g/10 min, or about 20 to about 500 g/10 min, or about 40 to about 300 g/10 min, or about 50 to about 250 g/10 min, as determined in accordance with ASTM method D1238 at 190° C. and 2.16 kg.

To obtain the ionomers useful in the ionomer compositions described herein, the precursor acid copolymers are neutralized with a base so that the carboxylic acid groups in the precursor acid copolymer react to form carboxylate groups. Preferably, the precursor acid copolymers groups are neutralized to a level of about 40% to about 90%, or about 40% to about 70%, or about 43% to about 60%, based on the total carboxylic acid content of the precursor acid copolymers as calculated or measured for the non-neutralized precursor acid copolymers.

Although any stable cation is believed to be suitable as a counterion to the carboxylate groups in an ionomer, for making the compositions of the invention monovalent cations, such as cations of alkali metals, are preferred. Still more preferably, the base is a sodium ion-containing base, to provide a sodium ionomer wherein about 30% to about 90%, or about 40% to about 90%, or about 40% to about 70%, or about 43% to about 60% of the hydrogen atoms of the carboxylic acid groups of the precursor acid are replaced by sodium cations. The particular level of neutralization of the ionomer is referred to as the neutralization ratio.

One embodiment of the invention is wherein the ionomer comprises an ethylenelmethacrylic acid copolymer having about 5 to 25 wt % methacrylic acid repeat units based on the weight of the ethylene/methacrylic acid copolymer; and more particularly, the ethylene/methacrylic acid copolymer has a neutralization ratio of 0.40 to about 0.70.

To obtain the ionomers used herein, the precursor acid copolymers may be neutralized by any conventional procedure, such as those disclosed in U.S. Pat. Nos. 3,404,134 and 6,518,365. Suitable ionomers for the invention are available from E.I. du Pont de Nemours and Co., Wilmington, Del., under the Surlyn® resin brand; or they can be prepared by synthesis.

The as-neutralized ionomer may have a MFR of about 0.1 to about 50 g/10 min or less, or about 0.2 to about 30 g/10 min or less, or about 0.3 to about 25 g/10 min, or about 0.5 to about 10 g/10 min, or about 0.6 to about 5 g/10 min, as determined in accordance with ASTM method D1238 at 190° C. and 2.16 kg.

The composition comprises 0.1 to 8.0 weight percent, preferably 0.5 to 6 weight percent, of polymeric toughener selected from the group consisting ethylene copolymers of the formula E/X/Y wherein:
E is the radical formed from ethylene;
X is selected from the group consisting of radicals formed from

CH₂═CH(R)—C(O)—OR²
wherein R¹ is H, CH₃ or C₂H₅, and R² is an alkyl group having 1-8 carbon atoms; vinyl acetate; and mixtures thereof;
Y is a radical formed from glycidyl (meth)acrylate and

wherein X comprises 0 to 50 weight percent, Y is about 2.0 to 15 weight percent, and E is the remainder weight percent of the E/X/Y copolymer. Y may be in the range of about 2.0 to 12 weight percent, about 2.0 to 10 weight percent and 2.0 to about 8 weight percent in the E/X/Y copolymer.

For the purposes of the description, unless otherwise specified, the term “(meth)acrylate” is meant to include acrylate esters and methacrylate esters.

The composition preferably has a weight ratio of ionomer to polymeric toughener of about 0.25 to 1 to 10 to 1. Other embodiments include a weight ratio of ionomer to polymeric toughener of about 0.33 to 1 to about 5 to 1, and 0.5 to 1 to about 5 to 1.

The composition may optionally comprise additional additives such as thermal, oxidative, and/or light stabilizers; colorants; lubricants; mold release agents; and the like. Such additives can be added according to the desired properties of the resulting material, and the control of these amounts versus the desired properties is within the knowledge of the skilled artisan.

Herein the composition is a mixture by melt-blending, in which all polymeric ingredients are adequately mixed, and all non-polymeric ingredients are adequately dispersed in a polymer matrix. Any melt-blending method may be used for mixing polymeric ingredients and non-polymeric ingredients of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained.

In another aspect, the present invention relates to a method for manufacturing an article by shaping the thermoplastic compositions disclosed herein. Examples of articles are automotive parts or engine parts or electrical/electronics parts. By “shaping”, it is meant any shaping technique, such as for example extrusion, injection molding, thermoform molding, compression molding or blow molding. Preferably, the article is shaped by injection molding or blow molding.

Another embodiment is the use of the compositions disclosed above in the formation of blow molded articles comprising:

extruding the melt blended compositions to provide a parison into a blow molding tool;

pinching parison at the top and bottom of the tool; inflating the parison within the closed blow molding tool;

holding the inflated parison with internal gas pressure until the walls cool and crystallize against the tool inner walls; and

removing the blow molded article from the tool.

Another embodiment is a composition, as disclosed above, wherein an injection molded test specimen, molded in a mold cavity having a length of 135.35 mm, width of 12.89 mm and depth of 3.23 mm and cut to a 60 mm length, has a flexural storage modulus retention of at least 20%, and preferably at least 25%, at 140° C. (E′₁₄₀, as compared to the flexural storage modulus at 23° C. (E′₂₃), as measured with dynamic mechanical analysis according to ISO6721-5, over a frequency range selected from 1 to 20 Hz. In various embodiments a 1 Hz, 5 Hz, 10 Hz, 15 Hz, and 20 Hz frequency can be used in the measurement, respectively. Another embodiment is a composition that has a flexural storage modulus retention as stated above, and a flexural storage modulus of at least 50 MPa at 140° C. Herein the term “high stiffness at elevated temperature” means the composition has a flexural storage modulus retention, E′₁₄₀/E′₂₃×100%, of at least 20%, and preferably at least 25%.

Another embodiment is a composition, as disclosed above, wherein compression molded test specimens prepared as defined by ASTM D 813 except having no 2 mm pierce, exhibits a total crack length of 20 mm or less on averaging three specimens after 200,000 cycles of bending according to ASTM D 813, at a test temperature of 100° C. Herein the term “flex fatigue resistance” means the composition exhibits a total crack length of 20 mm or less under the above stated conditions.

The compositions disclosed herein have one or more low temperature glass transition(s), defined as a glass transition between minus 100 and plus 150° C., and optionally a high temperature glass transition above 200° C. due to the presence of PPE. One embodiment is a composition, as disclosed above, wherein the largest of the one or more low temperature glass transition(s) is minus 25° C. or less, and preferably minus 30° C. or less; as measured with dynamic mechanical analysis according to ISO method 6721-5, at a frequency of 1 Hz, and a temperature scan rate of 2° C./min. The largest of the one or more low temperature glass transition(s) is defined as the glass transition of the largest tan delta peak in the DMA scan.

Another embodiment is a composition, as disclosed above, having a melt flow rate of 1.0 or greater, and preferably 1.2 or greater, as measured with the method of International Standard ISO 1133:1997(E) at a temperature of 230° C. under a 10 kg weight. Melt flow rate of about 1.0 or greater is particularly advantageous in manufacturing of blow-molded articles; where high throughput is necessary.

Another embodiment is the use of a composition comprising a melt mixed blend comprising:
52 to 96.9 weight percent one or more copolyoster thermoplastic elastomers;
3 to 40 weight percent polyphenylene ether; and
0.1 to 8 weight percent of polymeric toughener selected from the group consisting ethylene copolymers of the formula E/X/Y wherein:
E is the radical formed from ethylene;
X is selected from the group consisting of radicals formed from

CH₂═CH(R)—C(O)—OR²
wherein R¹ is H, CH₃ or C₂H₅, and R² is an alkyl group having 1-8 carbon atoms; vinyl acetate; and mixtures thereof; wherein X comprises 0 to 50 weight % of E/X/Y copolymer; and
Y is a radical formed from glycidyl (meth)acrylate;
   wherein the composition has a low temperature glass transition between minus 100 and plus 150° C.; in an application requiring a combination of high-stiffness at elevated temperature and melt flow rate of 1.0 or greater; a combination of high-stiffness at elevated temperature, melt flow rate of 1.0 or greater, and flex fatigue resistance; or a combination of high-stiffness at elevated temperature, melt flow rate of 1.0 or greater, flex fatigue resistance and a flexural storage modulus of at least 50 MPa at 140° C.

Another embodiment is a molded article comprising the compositions disclosed above. Specific molded articles are selected from the group consisting boots for auto drive shaft axle applications including CVJ (constant velocity joint) boots, propeller shaft joint boots, and other convoluted boots used to seal joint, linkages, or gears, in automotive vehicles; air ducts for automotive applications including fresh air ducts and pressurized inlet and outlet ducts used in turbocharged engines; and extruded tubes and pipes requiring high-stiffness at elevated temperature including air brake tubes.

### Methods

### Flexural Storage Modulus

Flexural storage modulus was determined with DMA measurements on injection molded test specimens. The test specimen mold cavity had a length of 135.35 mm, width of 12.89 mm and depth of 3.23 mm. Mold temperature was 45-55° C.; and melt temperature of the compositions were in the range of 245 to 265° C. The test specimens were cut to a length of 60 mm. DMA measurements were made using a TA Instruments model DMA Q800. The test specimens were clamped on a 35 mm dual cantilever clamp to provide a 17.5 mm distance between the center and end clamps. The measurement was made with a frequency selected from a range of 1 to 20 Hz, over a temperature range of minus 145° C. to +170° C. with a 2.0° C./minute ramp rate. Storage module at 23° C. (E′₂₃) and 140° C. (E′₁₄₀) was determined, and the ratio E′₁₄₀/E′₂₃×100% gave the retention of storage modulus.

### Glass Transition Temperature

Glass transition temperature was determined with DMA measurements on injection molded test specimens as described above. The test specimens were as measured with dynamic mechanical analysis according to ISO method 6721-5, at a frequency of 1 Hz, and a temperature scan rate of 2° C./min. The glass transition was considered the apex of the tan delta peak. Table 1 list two glass transitions for some comparative examples that exhibit two low temperature glass transitions.

Flex Fatigue resistance

Flex fatigue resistance was determined with a De Mattia Flex Fatigue Machine Model D, from Getty Machine and Mold Inc., on compression molded test specimens, prepared as defined by ASTM D 813 on a hot press at 250° C., with the exception that no 2 mm pierce of the test specimen was performed. A 5 Hz flex frequency was used. The average of total crack length of three test specimens was determined after 200,000 cycles of bending according to ASTM D 813, at a test temperature of 100° C. The maximum crack length in this test is the width of sample (25 mm).

### Durometer Hardness

Durometer hardness was measured by ISO method 868.

### Melt Flow Rate

Melt flow rate was measured using an Extrusion Plastometer MP 987 from Tinius Olsen on pellets according to the method of International Standard ISO 1133:1997(E) at a temperature of 230° C. under a 10 kg. Prior to melt flow rate measurements, the granules were dried under vacuum with a nitrogen purge for at least 8 hours at 80° C. Table 1 gives average values obtained from three measurements of one sample.

### Compounding

Melt mix blending of components listed in Table 1 for Examples and Comparative Examples was performed according to the following procedure. PPE resin and heat stabilizers listed in the Table 1 were fed to the rear of a ZSK 26 mm twin screw extruder (Coperion Corporation). Polyether ester copolymer, ionomer and E/X/Y ethylene copolymer were combined and fed to the extruder through a side feeder. The temperature of the extruder was set at 300° C. from the rear feeder to the point of the side feeder. The temperature of the extruder from the side feeder to a die was set at 260° C. A screw speed of 250 rpm and throughput of 11.34 kg/hour are typical conditions for the extrusion. Ingredient quantities shown in the Table are given in weight percent on the basis of the total weight of the thermoplastic composition.

### Materials

Polyether ester refers a polyether ester copolymer resin comprising about 52 weight percent of a short polyester repeat unit based on an ester of terephthalic acid and 1,4-butanediol and about 48 weight percent of a long polyester repeat unit based on a ester of terephthalic acid and poly(tetramethylene oxide) glycol of molecular weight of 1400, having a 50D Durometer hardness.

Hvtrel® HTR8341C BK is a polyether ester available from E.I. DuPont de Nemours and Company, Wilmington, Del., USA.

PPE refers Noryl® 640 polyphenylene ether resin available from GE Plastics.

E/X/Y-1 refers to an ethylene/butylacrylate/glycidyl methacrylate (66/22/12 weight ratio) terpolymer resin.

E/X/Y-2 refers to an ethylene/butylacrylate/glycidyl methacrylate (66/25/9 weight ratio) terpolymer resin.

Ionomer-A resin is a neutralized ethylene-methacrylic acid copolymer (11 wt % MAA, 58 mol % Na neutralized)

Irganox® 1010 stabilizer was available from Ciba Specialty Chemicals Inc, Switzerland.

Irganox® PS800 refers to dilauryl thiodipropionate available from Ciba Specialty Chemicals Inc, Switzerland.

Naugard® 445 hindered amine refers to 4,4′di(α,α-dimethylbenzyl)diphenylamine available commercially from Uniroyal Chemical Company, Middlebury, Conn.

LDPE refers to low density polyethylene of 0.929 g/cm³ and melting point of 115° C.

### Examples 1-6 and Comparative Examples C1-C3

The components listed in Table 1 for each composition were melt blended in an extruder as disclosed in the Methods section. Test specimens were prepared according to the methods disclosed in the Methods section and the results of physical testing are also listed in Table 1.

Examples 1-6 exhibit a melt flow rate of about 1.0 or greater while maintaining high stiffness at elevated temperature as evidenced by a E′₁₄₀/E′₂₃ of 23% or higher. Whereas Comparative examples C1-C3, comprising PPE but having no ionomer, show an E′₁₄₀/E′₂₃ of about 28-30%; but have a melt flow rate of 0.8 or less.

Comparative Example C1 has a melt flow rate of 0.6 versus that of Example 1 or 1.2. This is surprising and unexpected because addition of 0.9 weight percent of ionomer, resulted in a doubling of the melt flow rate. One would not expect a small change in composition to have such a large effect on melt flow rate; yet still maintain high stiffness at elevated temperature. A 62% improvement in melt flow rate is evident in comparing Comparative Example 03 with Example 3 at 20 wt % PPE.

TABLE 1

| | Example | | | | | | | | |
|---|---|---|---|---|---|---|---|---|---|
| | 1 | 2 | 3 | C1 | C2 | C3 | 4 | 5 | 6 |
| Polyether ester | 85.7 | 80.4 | 76 | 86.6 | 85.7 | 76.8 | 88.65 | 83.4 | 85.4 |
| PPE | 10 | 15 | 20 | 10 | 10 | 20 | 8 | 12 | 8 |
| E/X/Y-1 | — | — | — | — | — | — | — | — | — |
| E/X/Y-2 | 1.8 | 2 | 1.6 | 1.8 | 1.8 | 1.6 | 1 | 1 | 3 |
| Ionomer-A | 0.9 | 1 | 0.8 | 0 | 0 | 0 | 0.75 | 2 | 2 |
| Ionomer:E/X/Y ratio | 1:2 | 1:2 | 1:2 | — | — | — | 0.75:1 | 2:1 | 0.66:1 |
| LDPE | — | — | — | — | 0.9 | — | — | — | |
| Irganox ® 1010 | 0.3 | 0.3 | 0.3 | 0.3 | 0.3 | 0.3 | 0.3 | 0.3 | 0.3 |
| Irganox ® PS800 | 0.3 | 0.3 | 0.3 | 0.3 | 0.3 | 0.3 | 0.3 | 0.3 | 0.3 |
| Naugard ® 445 | 1 | 1 | 1 | 1 | 1 | 1 | 1 | 1 | 1 |
| Physical Properties | | | | | | | | | |
| Storage Modulus, 23° C. (MPa) (E′₂₃) | 152.4 | 236.8 | 205.9 | 162.2 | 153.6 | 223.1 | 159 | 191.3 | 154.2 |
| Storage Modulus, 140° C. (MPa) | 39.1 | 57.7 | 59.8 | 46.6 | 42.7 | 68.7 | 37.2 | 46.9 | 37.4 |
| (E′₁₄₀) | | | | | | | | | |
| % Retention (E′₁₄₀/E′₂₃) × 100% | 25.7 | 24.4 | 29.0 | 28.7 | 27.8 | 30.8 | 23.4 | 24.5 | 24.2 |
| Glass transition (° C.) | −37.2 | −35.5 | −34.9 | −36.1 | −37 | −40.1 | −37.9 | −42.3 | −34.2 |
| Melt flow rate, 230° C., 10 Kg (g/min) | 1.2 | 2.2 | 1.3 | 0.6 | 0.5 | 0.8 | 2.6 | 1.3 | 0.96 |
| Flex fatigue resistance, crack length | 1 | 23 | 25 | 0 | 0.2 | 25 | 5 | 8 | 1 |
| @ 200,000 cycles, @ 100° C. (mm) | | | | | | | | | |

Claimed is:

1. A composition comprising a melt mixed blend comprising:
a) 58 to 96.8 weight percent one or more copolyester thermoplastic elastomers;
b) 3 to 40 weight percent polyphenylene ether;
c) 0.1 to 6 weight % ionomer; and
d) 0.1 to 8 weight percent of polymeric toughener selected from the group consisting ethylene copolymers of the formula E/X/Y wherein:
E is the radical formed from ethylene;
X is selected from the group consisting of radicals formed from
CH₂═CH(R¹)—C(O)—OR²
wherein R¹ is H, CH₃ or C₂H₅, and R² is an alkyl group having 1-8 carbon atoms; vinyl acetate; and mixtures thereof; wherein X comprises 0 to 50 weight % of E/X/Y copolymer; and
Y is a radical formed from glycidyl (meth)acrylate;
wherein the composition has a low temperature glass transition between minus 100 and plus 150° C.

2. The composition of claim 1 wherein the ionomer is a sodium ionomer having a neutralization ratio of 30 to 90 mol %.

3. The composition of claim 1 wherein the ratio of ionomer to polymeric toughener is 0.25 to 1 to 10 to 1.

4. The composition of claim 1 wherein an injection molded test specimen, molded in a mold cavity having a length of 135.35 mm, width of 12.89 mm and depth of 3.23 mm and cut to a 60 mm length, has a flexural storage modulus retention of at least 20% at 140° C. (E′₁₄₀) as compared to the flexural storage modulus at 23° C. (E′₂₃), as measured with dynamic mechanical analysis according to ISO6721-5, over a frequency range selected from 1 to 20 Hz.

5. The composition of claim 1 wherein a compression molded test specimen, prepared as defined by ASTM D 813 except having no 2 mm pierce, exhibits a total crack length of 20 mm or less on averaging three specimens after 200,000 cycles of bending according to ASTM D 813, at a test temperature of 100° C.

6. The composition of claim 1 wherein said the largest of one or more low temperature glass transitions is minus 25° C. or less; as measured with dynamic mechanical analysis according to ISO method 6721-5, at a frequency of 1 Hz, and a temperature scan rate of 2° C./min.

7. The composition of claim 1 wherein the copolyester thermoplastic elastomer has a Durometer hardness of 55D or less, as measured by ISO method 868.

8. The composition of claim 1 having a melt flow rate of 1.0 or greater as measured with the method of International Standard ISO 1133:1997(E) at a temperature of 230′C under a 10 kg weight.

9. A molded article comprising the composition of claim 1.

10. The molded article of claim 9 selected from the group consisting of CVJ boots used in auto drive shaft axle applications, propeller shaft joint boots, and other convoluted boots used to seal joint, linkages, or gears, in automotive vehicles.
